(19) United States
(12) Patent Application Publication
(10) Pub. No.: US 2015/0206134 A1
(43) Pub. Date: Jul. 23, 2015

(54) ELECTRONIC GIFT CARD TRACKING SYSTEM AND METHOD

(71) Applicant: BBY SOLUTIONS, INC., Richfield, MN (US)

(72) Inventor: Scott Rodning, Northfield, MN (US)

(73) Assignee: BBY SOLUTIONS, INC., Richfield, MN (US)

(21) Appl. No.: 14/159,256

(22) Filed: Jan. 20, 2014

(51) Int. Cl. G06Q 20/34

(52) U.S. Cl. CPC G06Q 20/354; G06Q 20/342; G06Q 20/357

(57) ABSTRACT

Techniques and system configurations for tracking of electronic gift card activation and issuance transactions are described herein. In some described examples, a customer identifier is utilized during the gift card activation process to identify a particular purchaser (a customer). This customer identifier is provided in transactions among a gift card activator, a gift card processor, and a retailer (or other gift card redeeming or management entity) to enable the retailer to identify the customer that is activating a particular set of gift cards. This customer identifier is further used by the retailer to perform reconciliation of payments for the gift cards, and to associate respective gift cards from batch purchases with respective activators and customers.

### TECHNICAL FIELD

Embodiments pertain to electronic and gift card processing systems. Some embodiments relate to electronic software applications and related electronically-implemented processes that enable tracking and processing of electronic gift cards that are issued for use at retailers of goods and services.

### BACKGROUND

Gift cards are increasingly used for purchase transactions at both electronic and physical retail locations. As the usage of gift cards has increased, many businesses and consumers have increased the distribution and purchase of gift cards. For example, a large organization may conduct a transaction to purchase hundreds or thousands of gift cards at one time (these gift cards typically being redeemable at some retailer's chain of stores or website). The organization may then distribute individual gift cards for gifts or marketing purposes.

As the usage of gift cards in retail settings has increased, the usage and distribution of electronic gift cards has also increased, particularly for use in e-commerce and mobile payment settings. An electronic gift card typically includes a number or set of numbers (e.g., a card number and security code number) and in most cases is not associated with a physical gift card. Customers may be able to redeem electronic gift cards at a retail location by presenting the gift card numbers or a barcode or other electronic identifier representing the gift card numbers. The customer may also redeem the electronic gift card on a retailer's website by entering or accessing the gift card numbers during the electronic checkout process.

Electronic gift cards are able to be more quickly issued and distributed for use by organizations and end customers. However, existing gift card activation and issuance systems do not provide useful tracking and reconciliation mechanisms for the issuance process of large batches of electronic gift cards.

### BRIEF DESCRIPTION OF THE DRAWINGS

FIG. 1 illustrates interactions occurring among business entities that are involved in an electronic gift card tracking system according to an example described herein.

FIG. 2 illustrates processing activities occurring among business entities that are involved in an electronic gift card issuance process according to an example described herein.

FIG. 3 illustrates further processing activities occurring among business entities that are involved in the electronic gift card issuance process according to an example described herein.

FIG. 4A illustrates an example method for associating electronic gift card transactions with a customer, according to an example described herein.

FIG. 4B illustrates an example method for reconciling payments with electronic gift card activations, according to an example described herein.

FIG. 5 illustrates a block diagram of computing device system components adapted for processing electronic gift card tracking information according to an example described herein.

FIG. 6 is a block diagram illustrating operational components of a computing device upon which any one or more of the methodologies herein discussed may be run.

### DETAILED DESCRIPTION

The following description and drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some of the embodiments discussed herein describe techniques which enable tracking and management of information related to electronic gift card activation and issuance. A variety of entities, such as gift card activators, processors, aggregators, purchasers, and consumers are involved in gift card activation and issuance scenarios. These disparate entities are also involved at various points in the life cycle of the gift card, through activation, issuance, payment, and redemption processes. Further entities such as financial institutions and accounting systems may also be involved to exchange the various funds involved with the purchase and redemption of the gift card.

The retailer, where the gift card is redeemable at, is often interested in the exact activities occurring at the gift card activator and gift card processor entities that result in the sale and activation of the gift cards. However, few fields of information flow “downstream” from the gift card activator and gift card processor. Accordingly, the retailer may not know which particular gift card purchaser obtains which batch of gift cards from a particular activator, even if the gift card purchaser purchases hundreds or thousands of gift cards at a time.

Information on the gift card purchaser's purchase history and activity, and information related to the activation of the batches of gift cards, may provide the retailer with valuable tracking information. The retailer may wish to track, receive, and match payments from gift card purchasers to batches of gift cards, but such information is typically not available or is not provided to the end retailer in any direct fashion. Further, because there may be two or more other business entities (e.g., the gift card activator and the gift card processor) involved in an activation of the batch of gift cards, it may not be possible to correlate individual gift card numbers to payments and other transactions for the batch of gift cards.

In one embodiment, the gift card activation and issuance process is modified to include the use and communication of an identifier. This identifier can be used to identify a particular gift card purchaser (also referred to herein as a “customer”) in a “customer identifier” data field. As further described herein, this customer identifier may be communicated among the gift card purchaser, the gift card activator, and the retailer; later payment reconciliation activities at the retailer may also reference this customer identifier.

The customer identifier may be used to correlate gift card issuance (through other entities) with payments received for the customers. Accordingly, this correlation can provide the retailer with useful information and identification of the particular gift card batch transactions that were performed by a particular gift card purchaser. In addition, this correlation can be used in a payment reconciliation system to correlate later-received payment information with previously-performed gift card activations.

As further described herein, the electronic system configuration and method of implementation may involve operation enhancements throughout a gift card activation eco-system, that enable a retailer to track, receive and match payments for e-cards directly from the end user. This connection is missing, or unavailable, from current systems. With existing systems, limited amounts of data can be collected, and correlation of such electronic gift cards to received payments can only be made outside the activation eco-system by scheduled or ad hoc reporting.

The association of a customer identifier with gift card activation and issuance activities enables a retailer or other gift card management entity to track each card through downstream systems. Thus, a retailer can track a particular gift card or batch of gift cards, from third party activators and aggregators, to gift card processors, to the retailer, and throughout various processing systems of a retailer including accounting, reconciliation, and data warehouse systems.

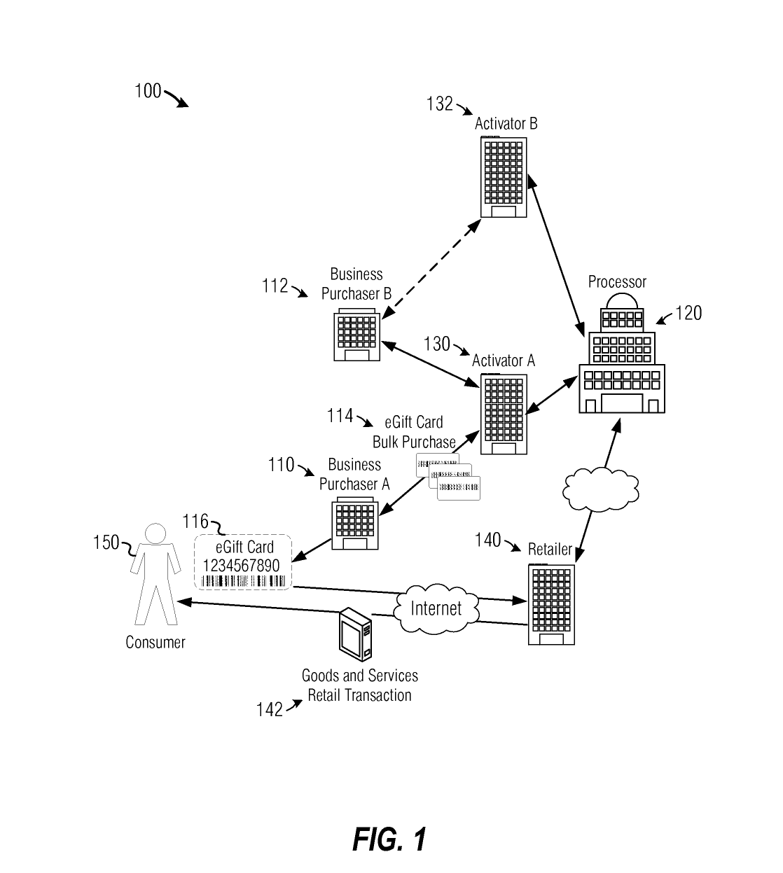

In this document, the following terms are introduced by the illustration 100 of FIG. 1, which depicts the interactions occurring among business entities that are involved in an electronic gift card tracking system. The following terms, which refer to specific items, entities, or roles fulfilled by an entity, are used to distinguish among the many entities (businesses and electronic systems) that are involved in a typical gift card issuance and processing transaction. The definition of these terms is provided for clarity and not as an exclusive definition. For example, it will be understood that a single entity or business may perform more than one of the following described roles. In addition, the roles involved with gift card issuance and processing may vary depending on financial institution requirements, legal regulations, or other factors.

The term “gift card” as used herein, illustrated by a gift card 116, refers to some representation of a stored or prepaid monetary value that is redeemable at a receiver such as a retailer 140 or like business entity. The funds associated with the gift card are typically maintained electronically by a party (such as a financial institution, an intermediate party, or a retailer itself) on behalf of the holder of the gift card. This gift card, when provided to the receiver in an electronic or digital form, is referred to as an “electronic gift card.” A gift card which is provided to the receiver in physical form is referred to as a “physical gift card,” and may be represented by a plastic card including a printed number or numbers, a magnetic strip, barcodes or QR codes, electronic transceiver, or other human or machine readable identifiers. An electronic gift card may be represented by a number or groups of numbers, barcodes or QR codes, or other human or machine readable identifiers, but the electronic gift card is typically not represented by a physically presentable card. An electronic gift card may be provided to an end user in any number of electronic formats, including but not limited to web page output, electronic mail messages, text/short message service (SMS) messages, smartphone application output, and the like.

The term “consumer” as used herein, illustrated by a consumer 150, refers to the party which ultimately receives a gift card, and uses the gift card to conduct a goods and services retail transaction 142 with the retailer 140 of some goods or services. The consumer 150 may receive the gift card 116 in a variety of fashions but typically after interaction with a business purchaser entity 110. The business purchaser entity 110, in turn, may provide the gift card 116 to the consumer 150 for free or as the result of a purchase or monetary exchange transaction.

The term “retailer” as used herein, illustrated by the retailer 140, refers to the entity such as a business where the gift card is redeemable at. The gift card 116 may be redeemed by the consumer 150 during a subsequent purchase of some goods or services, for example at a physical (e.g., “bricks-and-mortar”) location of the retailer. The purchase may be facilitated, for example, by presentation of a card number and a security code of the electronic gift card from the consumer 150 to the retailer 140; followed by a presentation of the card number and the security code from the retailer 140 to the gift card processor entity 120. The gift card 116 may also be redeemed by a party during a purchase of some goods or services in an electronic setting such as from an e-commerce website associated with the retailer.

The “business purchaser” as used herein, illustrated by the business purchaser entities 110 and 112, refers to a business entity which typically procures a group of gift cards, for example in an electronic gift card bulk purchase 114 from a gift card activator entity 130. A business purchaser typically has a contractual relationship with a particular gift card activator entity to obtain gift cards at some discounted rate. The business purchaser may, however, choose to obtain gift cards for a particular retailer from another gift card activator, such as from another gift card activator entity 132. The business purchaser may distribute the gift cards on its own, or may conduct sales and distribution of the gift cards in a B2B or B2C role (e.g., a distribution that ultimately results in the consumer 150 receiving the gift card 116).

The gift card “activator” or “aggregator” as used herein, illustrated by the gift card activator entities 130, 132, refers to a business entity which serves as an activation and distribution source of gift cards for a plurality of business purchasers (e.g., business purchaser B 112, business purchaser A 110). The gift card activator entity 130, in the case of electronic gift cards, will disperse the electronic gift card numbers to the particular purchaser (e.g., in the electronic gift card bulk purchase 114) and negotiate the activation of the electronic gift cards with a gift card processor entity 120.

The gift card “processor” as used herein, illustrated by the gift card processor entity 120, refers to a business entity which is responsible for managing and issuing gift cards and the values on these gift cards. For example, the retailer 140 may not wish to manage the issuance and management of thousands or millions of different gift card accounts, but instead will rely on the gift card processor entity 120 to handle the management of these accounts. In a typical scenario, the retailer 140 will have a network connection to the gift card processor entity 120 to redeem gift cards, determine what value is on a particular gift card, and determine what amount of gift cards have been purchased. The gift card processor entity 120 is in communication with the retailer 140 during the activation process and may inform the retailer 140 which particular cards have been purchased and activated.

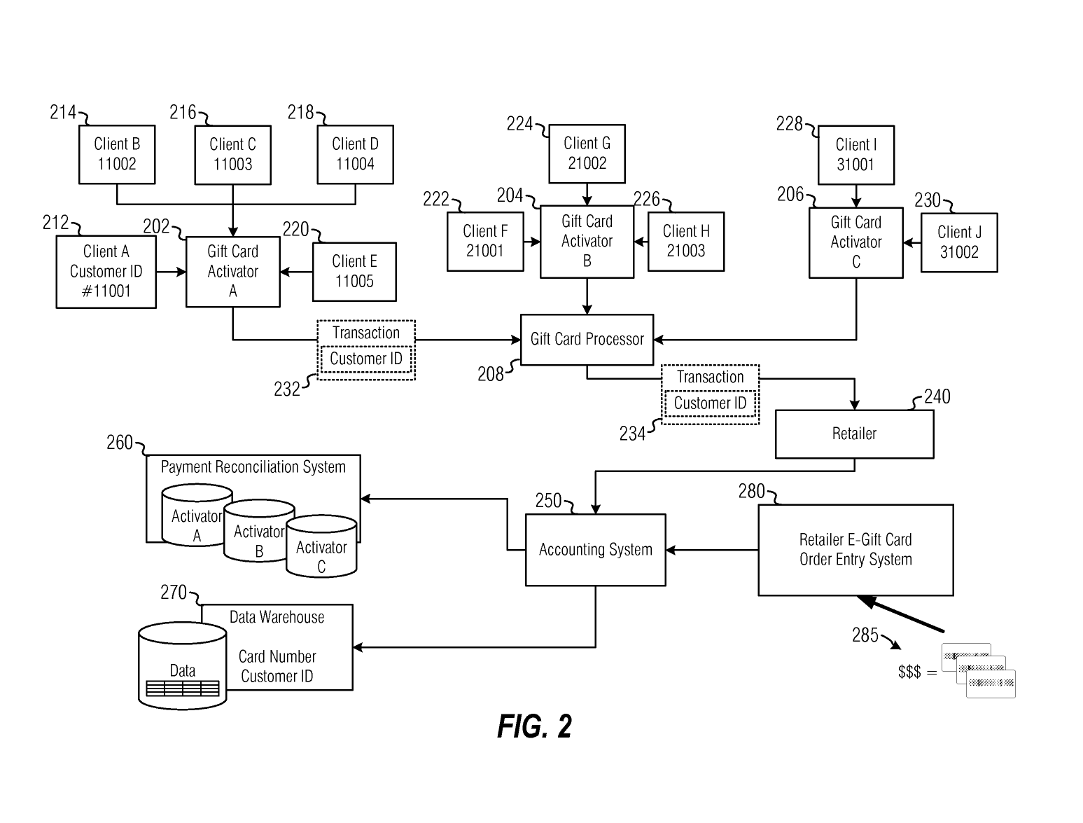

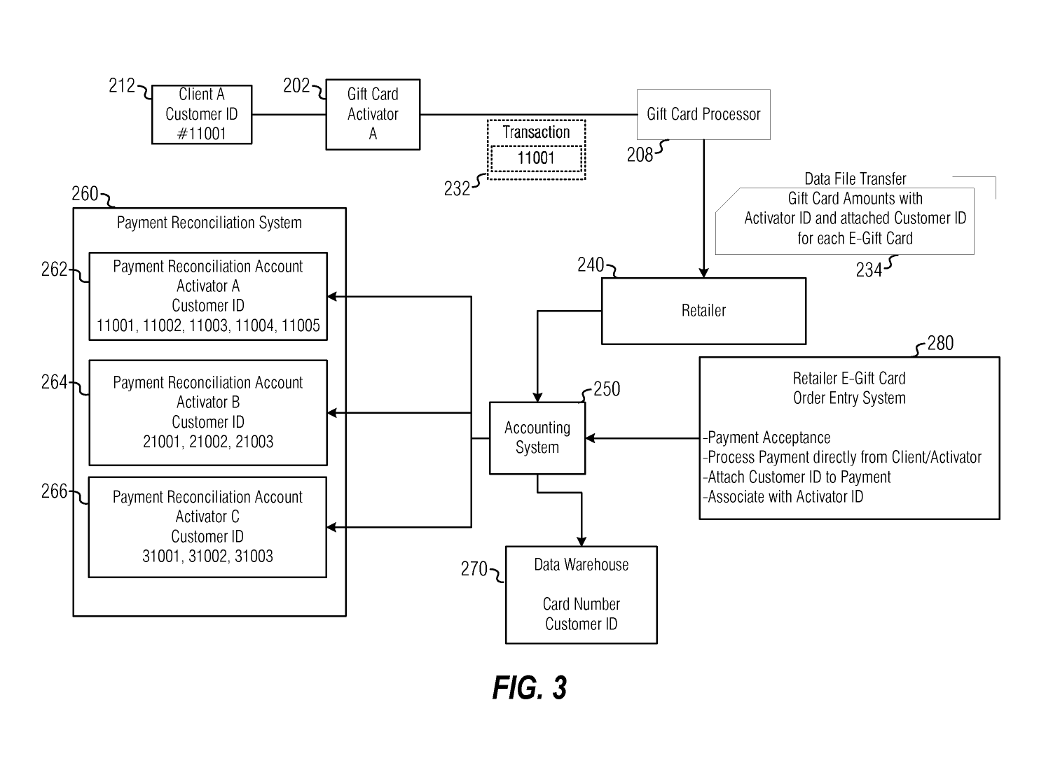

The “customer identifier,” as used herein, refers to some type of identifier, data value, or the like, which correlates to the particular business purchaser of the gift card. For example, a customer identifier may be assigned to each business purchaser or “client” that the retailer 140 approves to purchase and distribute electronic gift cards. (For example, the business purchaser A 110 may wish to sell the retailer's gift cards in the business-to-business (B2B) or business-to-consumer (B2C) market, which requires approval by the retailer 140). This customer identifier may be involved in future transactions among the gift card activator A 130, the gift card processor 120, and the retailer 140, to allow the retailer to track the particular gift card issuance and activation transactions. The following drawings, FIGS. 2 and 3, further describe such transactions that enable the customer identifier to become attached, in various transactions and back-office systems, to each electronic gift card upon activation.

FIG. 2 provides an enhanced illustration of processing activities occurring among business entities that are involved in an electronic gift card issuance process. As is shown, various gift card activators 202, 204, 206 each have associated “clients” (business purchasers who in turn may sell to other businesses or consumers). Gift card activator A 202 issues gift cards for clients A, B, C, D, E (212, 214, 216, 218, 220) respectively. Each of the business purchasers have an associated customer ID, illustrated as #11001, 11002, 11003, 11004, 11005 respectively for clients A, B, C, D, E. The gift card activator A 202 may require the use of the customer ID for performance any gift card activation transaction. For example, when Client A 212 requests activation of electronic gift cards, it also provides its unique customer ID to the gift card activator A.

The gift card activator A then provides the customer ID (e.g., #11011) when performing an electronic gift card activation transaction 232 with a gift card processor 208. This activation transaction 232 will identify the particular gift cards to activate (for example, to identify a particular batch of electronic gift cards to activate to defined values). The gift card processor 208 then establishes individual gift cards in the batch of electronic gift cards to be associated with the defined values. The customer ID may be communicated in a merchant identifier field communicated in the activation transaction 232 between the gift card activator entity 202 and the gift card processor entity 208.

The gift card processor 208 also has relationships with other gift card activators (e.g., gift card activator B 204, gift card activator C 206), and the other gift card activators have relationships with other customers (e.g., client F 222, client G 224, client H 226; and client I 228, client J 230). These respective customers also have unique identifiers (e.g., 21001, 21002, 21003; and 31001, 31002). As shown in FIG. 2, a portion of the identifier may be used to identify the particular gift card activator associated with the client (e.g., the first digit of the customer ID identifies gift card activator A, B, or C).

The gift card processor 208 provides the customer ID when performing an electronic gift card activation transaction 234 with retailer 240. This activation transaction 234 indicates the customer ID in addition to other information provided about the activation of the gift card(s), such as the particular amount of the respective gift cards. For example, the customer ID may be communicated in a merchant identifier field communicated in the activation transaction 234 between the gift card processor entity 208 and the retailer 240.

The customer ID communicated from the activation transaction 234 provides the retailer with an identifying audit tool for tracking gift cards activated in the respective electronic gift card purchase transactions. Clients (e.g., client 212) may be required to connect to an activator (e.g., activator A 202) to activate the gift cards, and this interaction with the activator may require the client (e.g., client 212) to attach the client ID to an activation transaction (232); likewise, the activator's transaction with the gift card processor 208 may require the activator (e.g., activator 202) to attach the client ID to an activation transaction (234). Accordingly, the retailer 240 can use the information to filter received data by activator and by client.

FIGS. 2 and 3 illustrate additional actions that occur after activation, to enable account reconciliation and tracking of the gift card activations. As shown in FIG. 2, the retailer provides the activation information to its accounting system 250. The accounting system 250 may be used to correlate gift card activations with particular gift card purchases from the client (e.g., client 212). This correlation can be used to reconcile the gift card activation transactions with a payment reconciliation system 260 with use of the received customer identifiers. For example, the payment reconciliation system 260 may be configured to reconcile sets of electronic gift card purchase payments from respective activators (e.g., gift card activator A 202, gift card activator B 204, gift card activator C 206) on a periodic basis, based on matching the activation transactions with payments received from particular activators and particular customers (identified by activator ID and customer ID). (The information from the activators will include activation transaction information for various gift card batch transactions including the activator ID and the customer ID).

The accounting system 250 may further provide the information to a data warehouse 270 that associates particular gift card numbers or gift card instances with customer identifiers. The accounting system 250 is further connected to establish a connection with the retailer's e-gift card order entry system 280. The order entry system 280 is used to facilitate payment directly from clients or activators. (In some examples, activators may pay on behalf of clients for gift card purchases; in other examples, clients may directly provide the retailer with payment for gift card purchases).

FIG. 3 provides an enhanced illustration of reconciliation and processing operations in connection with the system components that are also illustrated in FIG. 2. For example, FIG. 3 illustrates some of the information fields that are exchanged between the gift card processor 208 and the retailer 240 in a data file transfer 234. This data file transfer 234 includes information such as respective gift card amounts and card numbers for the electronic gift cards that are being activated, with the activator ID and customer ID attached for each electronic gift card. The retailer 240 can then use this information in its internal systems to correlate specific gift card purchase amounts with respective activators and clients.

FIG. 3 also illustrates the operations performed in the order entry system 280 for payment for the group of electronic gift cards with the retailer. The order entry system 280 allows a client or activator to order electronic gift cards in real time, through the attachment of the customer identifier to the payment (for later use in reconciliation). The operations performed by the order entry system 280 may include payment acceptance from clients or activators (e.g., through credit card or ACH processing); processing and receiving the payment from a particular client or activator; attaching a customer identifier to the payment; association and tracking of the payment with a particular activator identifier. The order entry system 280 thus may allow the retailer to take payment directly from clients for electronic gift card transactions. For example, such direct payments can allow the retailer to control the gift card purchase transactions, and provide discounts to particular clients based on volume or other factors.

FIG. 3 further illustrates the operations performed in connection with the accounting system 250 connected with a retailer 240. The accounting system 250 is configured to reconcile payments received at the retailer from respective activators, with electronic gift card batch activations and individual electronic gift card activations conducted “up-stream” at the activators and processors (and out of the retailer's control). FIG. 3 illustrates that the accounting system 250 accesses a payment reconciliation system 260 which provides payment reconciliation accounts that stores reconciliation information for respective activators (e.g., a payment reconciliation account 262 for activator A; a payment reconciliation account 264 for activator B; a payment reconciliation account 264 for activator C).

The reconciliation process conducted by the retailer 240 may operate similar to the following example. The retailer 240 sets aside the funds for the gift cards and associates it with the card numbers of the particular electronic gift cards. The retailer 240 reconciles gift card transactions for periodic activity at a defined interval (every day, every week) after receiving information from the activator that indicates which electronic gift cards were purchased (with accompanying customer identifiers). The retailer 240 will then expect payments from the various customers, which may be received from the activator or the client through the order entry system 280. The order entry system 280 will provide payments with attached activator identifiers and customer identifiers to the accounting system. The retailer 240 will then examine the accounting system 250 to reconcile the received funds with the information in the payment reconciliation system 260, based on the activator identifiers and customer identifiers. This reconciliation process enables post-payment for large batch transactions (and in particular, large B2B transactions) of electronic gift cards. This is in contrast to existing payment processing systems where pre-payment often must be received and processed before issuing batches of electronic gift cards. This post-paying configuration allows electronic gift cards to be more quickly activated and issued to activators (and in turn, clients and end consumers).

As a result of this configuration, the customer ID is passed from the gift card activator to the gift card processor (and from the gift card processor to the retailer) each time. Whether the client procures 500 cards or 5, each card will have a customer identifier attached to it. In essence, the customer identifier serves as an additional data field to accompany information that is exchanged already between participants in the gift card activation process.

In some examples, new data fields may be defined and provided to exchange the customer identifier between the activator and the processor, and the processor and the retailer. In other examples, existing transactional fields may be utilized, to accompany the customer identifier for a particular transaction with other fields of data.

The use of the customer identifier in this fashion may assist the portability of the customer identifier, even if the business purchaser or client moves from a first activator to a second activator. Further, use of the customer identifier allows the retailer to track and segment activity from individual customers, rather than just observing bulk business from an activator.

The client identifier also serves as a tracking “cookie” that is deployed at the client level, which is passed downstream during the activation process to the retailer. A variety of customer information analytics may be performed on a per-customer based for large batches of gift card purchases. For example, the retailer may determine the average purchase price for gift cards, the year to date spending for a particular customer, conversion rates of gift cards by a customer, and the like. Information also may be further correlated with usage of the gift cards by consumers at a later time.

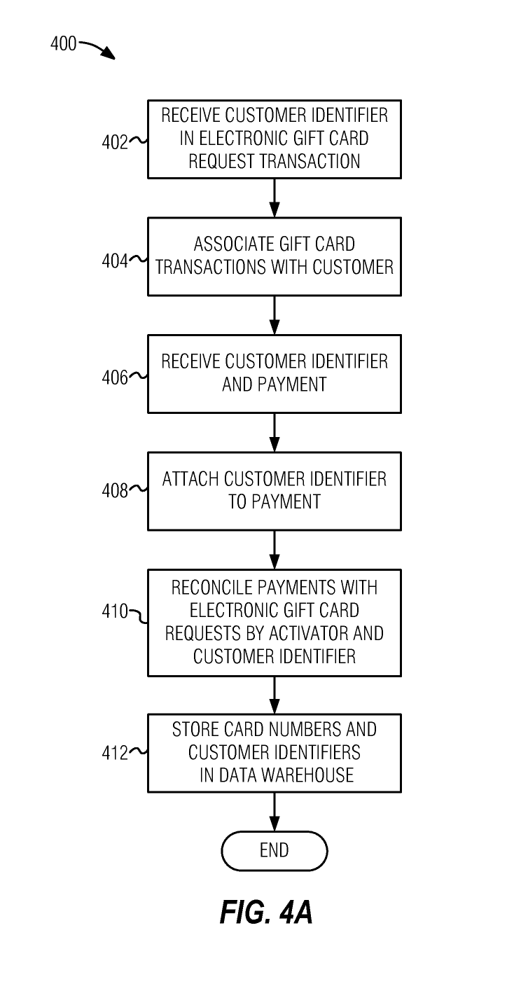

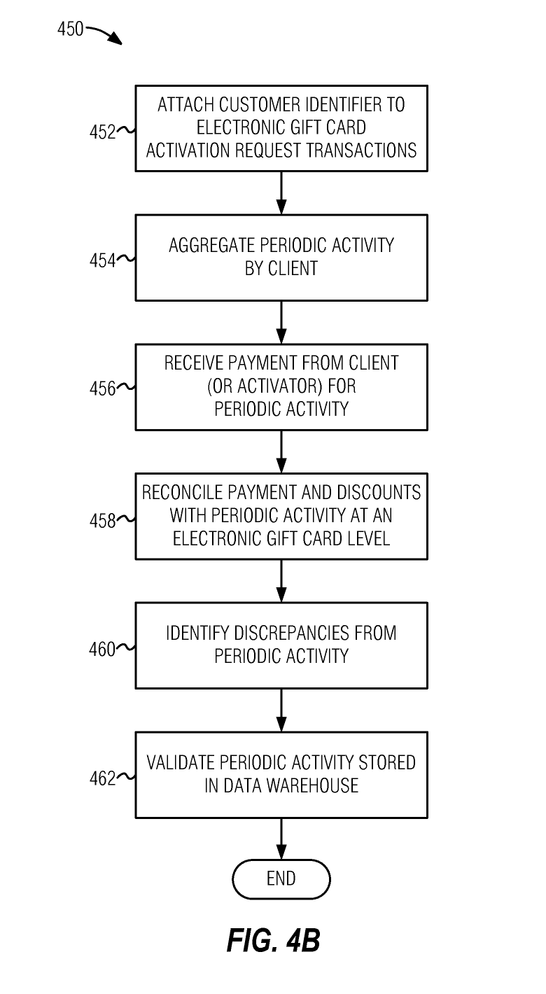

FIG. 4A illustrates an example method 400 for associating electronic gift card transactions with a customer, according to an example described herein. The method 400 may be implemented in hardware or software within one or more of the electronic processing systems of a retailer, service provider (including one or more outsourced service providers), or data processor; and such operations may be split across multiple entities. Accordingly, it will be understood that this method may be implemented with a computerized or electronic process that involves minimal or no human interaction.

As illustrated, the method 400 to associate the electronic gift card transactions will include the receiving of a customer identifier in an electronic gift card request transaction (operation 402). The gift card request transaction provides an indication for activation (and purchase) of one or more gift cards or batches of gift cards, and may be provided to the retailer directly or at a service provider intermediary. The retailer or its service provider will then associate the gift card request transactions with the particular customer (client) (operation 404), with use of the customer identifier.

The retailer or its service provider will then receive a payment accompanied by the customer identifier (operation 406) in a payment processing system such as the order entry system 280. This payment will be stored in an appropriate accounting system such as the accounting system 250, and the customer identifier will be associated with or attached to the particular received payment (operation 408). At this point in the example process, the gift cards have been activated and issued, and payment received for the activated and issued gift cards.

The remaining processing activity for the retailer and service provider involves further data reconciliation and tracking, which may occur at a periodic basis or in response to some determined condition. The reconciliation (operation 410) may include a payment reconciliation that involves reconciling payments received (e.g., received in operation 406) with the activation request (e.g., received in operation 402) based on the use of activator identifiers and customer identifiers. For example, this reconciliation may involve the use of a payment reconciliation system 260 that reconciles information received from activators for a plurality of clients on a periodic basis. In addition, other information for the payments and processing may be stored before or after payment reconciliation, such as the association of respective electronic gift card numbers or data fields with customer identifiers, stored in a data warehouse (operation 412).

FIG. 4B illustrates an example method 450 for performing reconciliation of an electronic gift card purchase transaction according to a further example. Additionally, the method 450 may be implemented in hardware or software within one or more of the electronic processing systems of a retailer, service provider, or data processor (and as steps in substitute or addition to those of FIG. 4); and such operations may be split across multiple entities. Accordingly, it will be understood that this method may be implemented with a computerized or electronic process that involves minimal or no human interaction.

As illustrated, the method 450 to perform reconciliation of an electronic gift card purchase transaction may include the attachment of a customer identifier to the respective electronic gift card activation request transactions (operation 452). These transactions may occur in batches or over a period of time, and may be followed by further operations that store and track the various electronic gift card numbers or identifiers in a database, data warehouse, or other data store location.

The periodic activity for the activation requests may be aggregated by client (operation 454), and received in batches that are communicated from activator entity (that may be received periodically or only at certain times). Payments for the activations, however, may be received on an ongoing basis directly from the client or from the aggregator for the various activation requests (operation 456).

The reconciliation will involve reconciling the payment required from particular client (and purchase discounts available to the particular client), and the payment actually received for the particular client, with the periodic activation activity reported by the activator (operation 458). The reconciliation may be performed on a card-by-card basis (or in some examples, may involve batches or purchase transactions of sets of cards). From this reconciliation, discrepancies in the periodic activity may be identified (operation 460), and other information in a data warehouse or other stored location (e.g., accounting system, etc.) may be validated (operation 462).

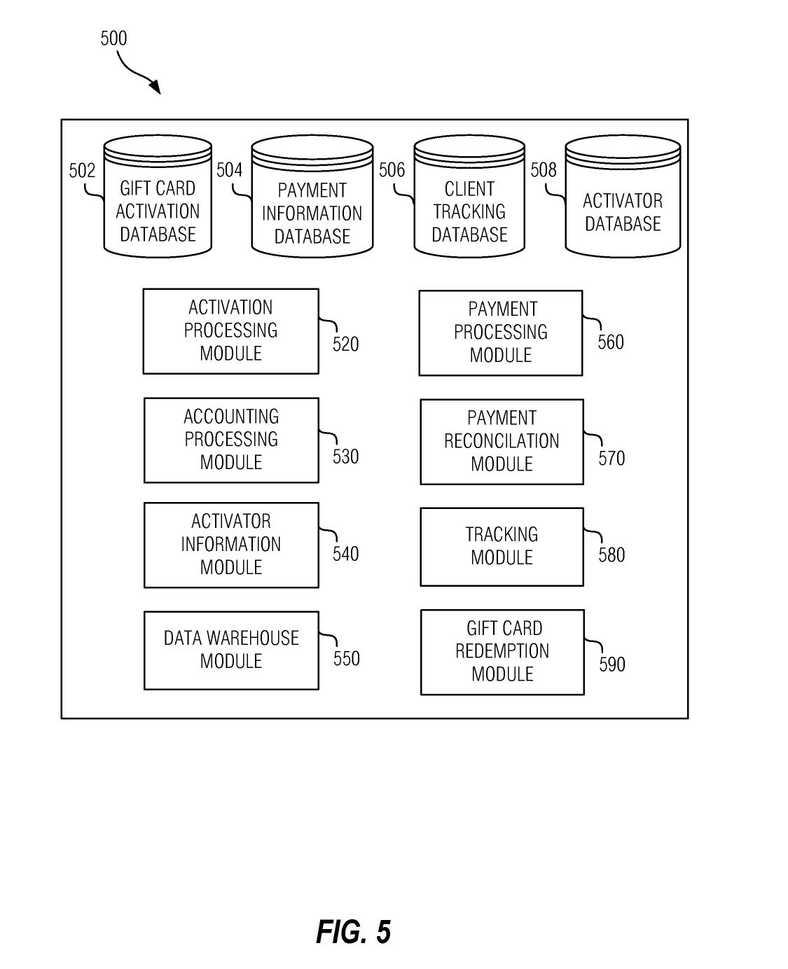

FIG. 5 illustrates a block diagram of a computing system 500 with components adapted for processing a customer identifier for use by a retailer in tracking electronic gift card activations by respective customers. The computing system 500 may include a processor, memory, operating system, and user input interface to operate and provide interaction with the system 500. The computing system may be implemented within one or a plurality of computer systems, and be implemented as a remote or cloud-based processing system.

The computing system 500 is configured to implement a plurality of modules or components for retailer processing the gift card processing transactions described above. The computing system 500 is also configured to implement and maintain a plurality of data stores for storing data used in processing the gift card processing transactions described above. A description of the following modules and data sources follows, but it will be understood that functionality and operation of the various databases and modules may be consolidated into fewer or expanded into additional databases or modules.

The computing system 500 is depicted as including: a gift card activation database 502 for storing activation information for particular gift cards and batches of gift cards; a payment information database 504 for storing information on payments received from purchasers of the gift cards; a client tracking database 506 used for storing information that enables tracking of individual clients (e.g., business purchasers) of gift cards; and an activator database 508 used for storing information on particular gift card activator entities. Additional data stores may also be used to track other entities involved in the gift card activation process such as a processor database (not shown).

The computer system 500 is also depicted as including a series of modules or components providing functionality for implementing the gift card activation tracking. The modules or components include: an activation processing module 520 used for processing electronic gift card activation requests received by the retailer; an accounting processing module 530 used for performing accounting operations related to the gift card activation, payment, and reconciliation; an activator information module 540 used for maintaining information on particular activator operations; a data warehouse module 550 used for storing information in a data warehouse such as a correlation between individual gift card numbers and customer identifiers; a payment processing module 560 used for processing payments received for gift card purchases; a payment reconciliation module 570 used for reconciling payments received for the gift card purchase with activation information received from the gift card processor; a tracking module 580 used for tracking activity of activators, processors, individual customers, gift card batches, or individual gift cards; a gift card redemption module 590 used to enable end consumers to redeem the value associated with the gift card for purchase transactions involved with the purchase of goods and services.

Embodiments used to facilitate and perform the techniques described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

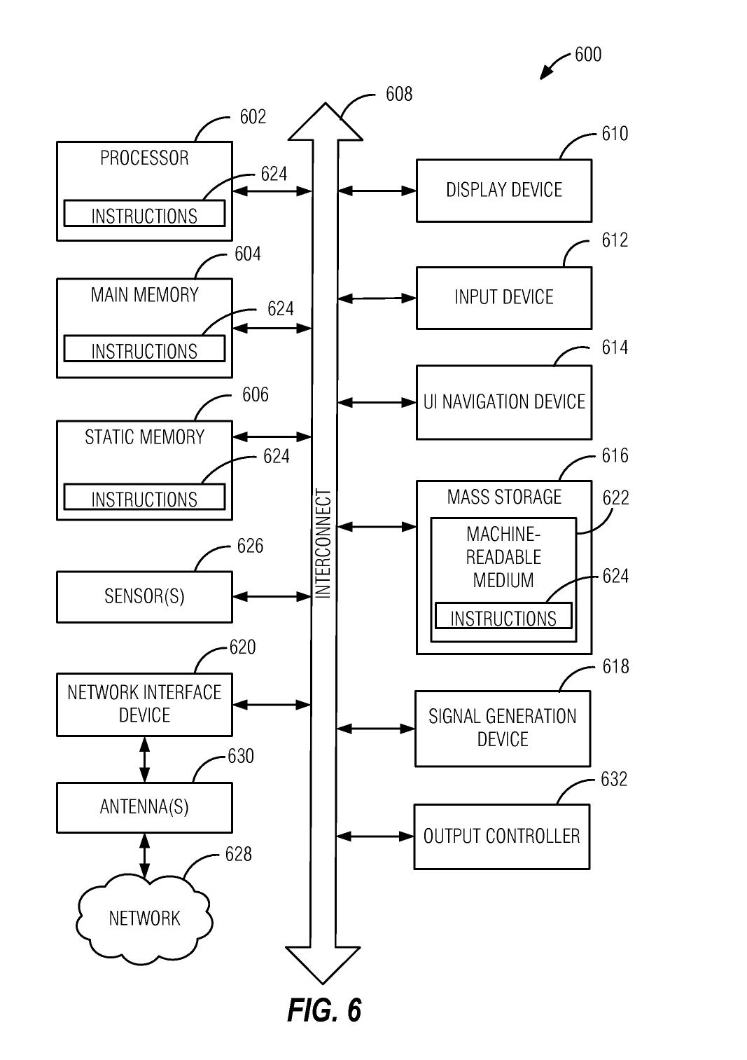

FIG. 6 is a block diagram illustrating a machine in the example form of a computer system 600, within which a set or sequence of instructions may be executed to cause the machine to perform any one of the methodologies discussed herein, according to an example embodiment. Computer system machine 600 may be embodied by the electronic processing systems implemented at the consumer 150, business purchaser 110, 112, activator 130, 132, processor 120, or retailer 140; by the electronic processing systems at activator entities 202, 204, 206, the gift card processor entity 208, and retailer 240; the accounting system 250, payment reconciliation system 260, data warehouse 270, and order entry system 280; the system(s) implementing the databases 502, 504, 506, 508; the system(s) implementing the various modules or components 520, 530, 540, 550, 560, 570, 580, 590; or any other electronic processing or computing platform described or referred to herein.

In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via an interconnect 608 (e.g., a link, a bus, etc.). The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touchscreen interface and touchscreen display. The computer system 600 may additionally include a storage device 616 (e.g., a drive unit), a signal generation device 618 (e.g., a speaker), an output controller 632, a network interface device 620 (which may include or operably communicate with one or more antennas 630, transceivers, or other wireless communications hardware), and one or more sensors 626, such as a global positioning system (GPS) sensor, compass, accelerometer, location sensor, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communications network 628 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 2G/3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Additional examples of the presently described method, system, and device embodiments include the configurations recited by the claims. Each of the examples in the claims may stand on its own, or may be combined in any permutation or combination with any one or more of the other examples provided below or throughout the present disclosure.

What is claimed is:

1. A method performed by a computing device for managing activation of electronic gift cards, comprising:
receiving, from a gift card processor entity, an electronic indication of an activation transaction for an electronic gift card, the electronic indication including a customer identifier associated with a business customer entity to receive the electronic gift card;
associating, in an electronic database, the customer identifier with a card number of the electronic gift card; and
reconciling, in an electronic accounting system, a payment received for the electronic gift card with the activation transaction of the electronic gift card using the customer identifier;
wherein the gift card processor entity is provided with the customer identifier from a gift card activator entity, and wherein the electronic gift card is provided to the business customer entity through another transaction between the business customer entity and the gift card activator entity.

2. The method of claim 1, wherein the electronic indication for the activation transaction is provided in an electronic indication for an activation transaction of a plurality of electronic gift cards, wherein the plurality of electronic gift cards includes the electronic gift card, wherein the plurality of electronic gift cards are associated with respective card numbers, and wherein associating the customer identifier with the card number results in card numbers of the plurality of electronic gift cards being associated with the customer identifier.

3. The method of claim 2, wherein the business customer entity requests the activation transaction of the plurality of electronic gift cards through the gift card activator entity, wherein the business customer entity provides the plurality of electronic gift cards to respective recipients in a business to business (B2B) or business to consumer (B2C) transaction after the activation transaction, and wherein the respective recipients are provided with the respective card numbers of the plurality of electronic gift cards to enable a subsequent purchase of goods or services at a retailer.

4. The method of claim 1, wherein the electronic indication of the activation transaction is provided in a data file transfer from the gift card processor entity, wherein the data file transfer includes a value amount and the card number of the electronic gift card.

5. The method of claim 1, comprising:
receiving, with an electronic payment system from the gift card activator entity or the business customer entity, the payment for the electronic gift card and the customer identifier; and
receiving, from the gift card activator entity, electronic activation records of a plurality of activation transactions for a plurality of electronic gift cards including the activation transaction of the electronic gift card;
wherein reconciling the payment received for the electronic gift card with the activation transaction of the electronic gift card includes correlating the customer identifier with a particular activation transaction in the plurality of activation transactions conducted between the business customer entity and the gift card activator entity.

6. The method of claim 1, comprising:
storing, in a data warehouse, the card number of the electronic gift card in an association with the customer identifier.

7. The method of claim 1, wherein the customer identifier is provided in a merchant identifier field communicated between the gift card activator entity and the gift card processor entity in the another transaction, wherein the gift card processor entity performs management of issuance and redemption of the electronic gift card.

8. The method of claim 7, wherein the customer identifier is provided in a merchant identifier field communicated between the gift card processor entity and the computing device receiving the electronic indication of the activation transaction.

9. The method of claim 1, wherein the electronic gift card is associated with the card number and a security code, wherein redemption of the electronic gift card includes presentation of the card number and the security code to the gift card processor entity.

10. A machine-readable medium including instructions for managing activation transactions for electronic gift cards, the instructions which when executed by a computing system cause the computing system to perform operations including:
processing an electronic indication of an activation transaction for an electronic gift card received from a gift card processor entity, the electronic indication including a customer identifier associated with a business customer entity to receive the electronic gift card;
associating the customer identifier with a card number of the electronic gift card; and
reconciling a payment received for the electronic gift card with the activation transaction of the electronic gift card using the customer identifier;
wherein the gift card processor entity is provided with the customer identifier from a gift card activator entity; and
wherein the gift card processor entity performs management of issuance and redemption of the electronic gift card.

11. The machine-readable medium of claim 10, wherein the electronic indication for the activation transaction is provided in an electronic indication for an activation transaction of a plurality of electronic gift cards, wherein the plurality of electronic gift cards includes the electronic gift card, wherein the plurality of electronic gift cards are associated with respective card numbers, and wherein associating the customer identifier with the card number results in card numbers of the plurality of electronic gift cards being associated with the customer identifier.

12. The machine-readable medium of claim 11, wherein the business customer entity requests the activation transaction of the plurality of electronic gift cards through the gift card activator entity, wherein the business customer entity provides the plurality of electronic gift cards to respective recipients in a business to business (B2B) or business to consumer (B2C) transaction after the activation transaction, and wherein the respective recipients are provided with respective card numbers of the plurality of electronic gift cards to facilitate a subsequent purchase of goods or services at a retailer.

13. The machine-readable medium of claim 10, the instructions which when executed by the computing system further cause the computing system to perform operations including:
receiving, with an electronic payment system from the gift card activator entity or the business customer entity, the payment for the electronic gift card and the customer identifier; and
receiving, from the gift card activator entity, electronic activation records of a plurality of activation transactions for a plurality of electronic gift cards including the activation transaction of the electronic gift card;
wherein reconciling the payment received for the electronic gift card with the activation transaction of the electronic gift card includes correlating the customer identifier with a particular activation transaction in the plurality of activation transactions conducted between the business customer entity and the gift card activator entity.

14. The machine-readable medium of claim 10, wherein the customer identifier is provided to the gift card processor entity in a merchant identifier field communicated between the gift card activator entity and the gift card processor entity in another transaction, wherein the gift card processor entity performs management of issuance and redemption of the electronic gift card.

15. The machine-readable medium of claim 14, wherein the customer identifier is provided in a merchant identifier field communicated between the gift card processor entity and the computing system receiving the electronic indication of the activation transaction.

16. A computing device comprising:
a hardware processor and memory;
one or more databases; and
an activation processing module implemented in connection with the hardware processor and the memory, the activation processing module configured to perform operations that:
process an electronic indication of an activation transaction for an electronic gift card, the electronic indication received from a gift card processor entity, and the electronic indication including a customer identifier associated with a business customer entity to receive the electronic gift card;
associate the customer identifier with a card number of the electronic gift card in the one or more databases; and
establish data for reconciling a payment received for the electronic gift card with the activation transaction of the electronic gift card using the customer identifier;
wherein the gift card processor entity is provided with the customer identifier from a gift card activator entity, and wherein the electronic gift card is provided to the business customer entity through another transaction between the business customer entity and the gift card activator entity.

17. The computing device of claim 16, comprising:
a payment processing module implemented in connection with the hardware processor and the memory, the payment processing module configured to perform operations that:
process the payment for the electronic gift card, the payment accompanied by the customer identifier, wherein the payment is received from the gift card activator entity or the business customer entity; and
a payment reconciliation module implemented in connection with the hardware processor and the memory, the payment reconciliation module configured to perform operations that:
process electronic activation records of a plurality of activation transactions for a plurality of electronic gift cards including the activation transaction of the electronic gift card, the electronic activation records received from the gift card activator entity; and
correlate the customer identifier with a particular activation transaction in the plurality of activation transactions conducted between the business customer entity and the gift card activator entity.

18. The computing device of claim 16, wherein the electronic indication for the activation transaction is provided in an electronic indication for an activation transaction of a plurality of electronic gift cards, wherein the plurality of electronic gift cards includes the electronic gift card, wherein the plurality of electronic gift cards are associated with respective card numbers, and wherein associating the customer identifier with the card number results in card numbers of the plurality of electronic gift cards being associated with the customer identifier.

19. The computing device of claim 18, wherein the business customer entity requests the activation transaction of the plurality of electronic gift cards through the gift card activator entity, wherein the business customer entity provides the plurality of electronic gift cards to respective recipients in a business to business (B2B) or business to consumer (B2C) transaction after the activation transaction, and wherein the respective recipients are provided with respective card numbers of the plurality of electronic gift cards to perform a subsequent purchase of goods or services at a retailer.

20. The computing device of claim 16, wherein the electronic indication of the activation transaction is provided in a data file transfer received from the gift card processor entity, wherein the data file transfer includes a value amount and the card number of the electronic gift card.

21. The computing device of claim 16, wherein the customer identifier is provided in a merchant identifier field communicated between the gift card activator entity and the gift card processor entity in the another transaction;
wherein the gift card processor entity performs management of issuance and redemption of the electronic gift card; and
wherein the customer identifier is provided in a merchant identifier field communicated between the gift card processor entity and the computing device.
